(19) United States
(12) Patent Application Publication
(10) Pub. No.: US 2016/0378296 A1
(43) Pub. Date: Dec. 29, 2016

(54) Augmented Reality Electronic Book Mechanism

(71) Applicants: Ashok Mishra, Portland, OR (US); Rajesh Poornachandran, Portland, OR (US); Saurabh Dadu, Tigard, OR (US); Ravikiran Chukka, Portland, OR (US); Mallikarjuna Chilakala, Tigard, OR (US)

(72) Inventors: Ashok Mishra, Portland, OR (US); Rajesh Poornachandran, Portland, OR (US); Saurabh Dadu, Tigard, OR (US); Ravikiran Chukka, Portland, OR (US); Mallikarjuna Chilakala, Tigard, OR (US)

(21) Appl. No.: 14/750,259

(22) Filed: Jun. 25, 2015

(51) Int. Cl. G06F 3/0481; G06T 11/00; G06T 15/00; G06F 1/16; G06F 17/30; G06T 19/00; G06F 3/01

(52) U.S. Cl. CPC G06F 3/04815; G06T 19/006; G06T 11/00; G06F 3/011; G06F 1/163; G06F 17/30696; G06T 15/005; G06F 3/017; G09G 2380/14

(57) ABSTRACT

A method is described to facilitate augmented reality. The method includes receiving image data from a book, extracting features from the image data as the book as being read, comparing the extracted features to previously stored data in the database, retrieving page data associated with the extracted features upon detecting a comparison match, overlaying the page data on a book page currently being viewed and displaying the page data on the book page currently being viewed.

### FIELD

Embodiments described herein generally relate to wearable computing. More particularly, embodiments relate to reading enhanced wearable devices.

### BACKGROUND

Paper books lack a sophisticated user experience that an electronic book (e-book) reader may enjoy (e.g., virtual highlighting, note-taking and book marking, dictionary lookup, and cross-referencing to outside sources). As a result, e-books have become popular due to such experience enhancements to reading. However, limitations to the reading of e-books still exist.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an augmented reality mechanism at a computing device according to one embodiment.

FIG. 2 illustrates one embodiment of an augmented reality mechanism.

FIG. 3 is a flow diagram illustrating one embodiment of a process performed by a augmented reality mechanism.

FIG. 4 illustrates a computer system suitable for implementing embodiments of the present disclosure.

### DETAILED DESCRIPTION

Embodiments may be embodied in systems, apparatuses, and methods for augmented book reading, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for an augmented reality mechanism that receives image data upon a camera implemented in a wearable device, such as a smart glass device, scanning a compilation of written sheets, such as a book, and dynamically provides user defined metadata. For instance, the augmented reality mechanism permits a user reading a traditional book to virtually highlight lines/sections of the book using a gesture, such as swiping a finger through the lines or circling around a paragraph. In such an embodiment, gestures are identified and processed, and corresponding actions are taken. When the user reads that book again, the augmented reality mechanism remembers the lines that the user highlighted earlier and virtually highlights them again.

According to one embodiment, virtual or augmented information is displayed on a display device at the wearable device such that the information is either overlaid over the appropriate sections of the physical book (e.g., in case of virtually highlighted sections) or on the sides to enhance user experience. In a further embodiment, the augmented reality mechanism receives a captured image of open pages and processes the image through optical character recognition (OCR), image processing and augmented reality algorithms. In other embodiments, books are identified and corresponding metadata is created, or recalled, from a local (or cloud) database. In a further embodiment, the information may be processed by a cloud server in a crowd-sourced manner.

Throughout this document, terms like “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, such as “avatar”, “avatar scale factor”, “scaling”, “animation”, “human face”, “facial feature points”, “zooming-in”, “zooming-out”, etc., should not be read to limit embodiments to software or devices that carry that label in products or in literature external to this document.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

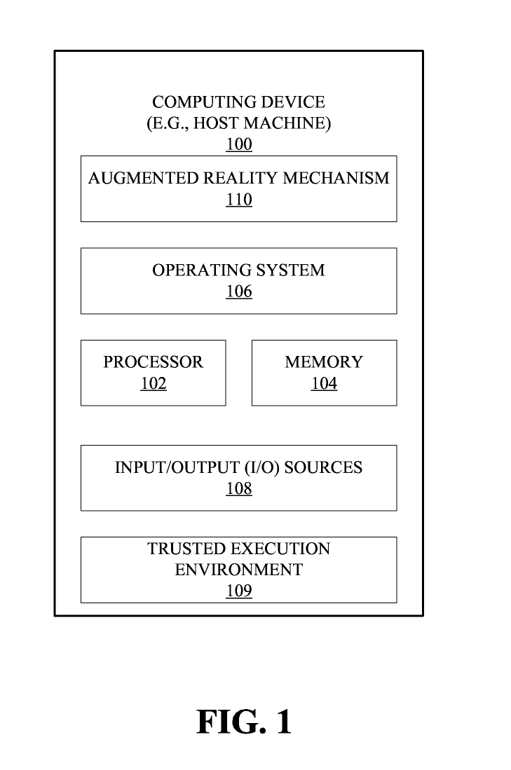

FIG. 1 illustrates one embodiment of an augmented reality mechanism 110 at a computing device 100. In one embodiment, computing device 100 serves as a host machine for hosting augmented reality mechanism 110 that includes a combination of any number and type of components to augment user reading experiences at computing devices, such as computing device 100. In one embodiment, computing device 100 includes a wearable device. Thus, implementation of augmented reality mechanism 110 results in computing device 100 being an assistive device to a wearer of computing device 100 to generate dynamic virtual information based on user gestures resulting from interaction with a book. In a further embodiment, computing device 100 is an optical head-mounted display (OHMD) device.

In other embodiments, augmented reality operations may be performed at a computing device 100 including large computing systems, such as mobile computing devices, such as cellular phones including smartphones, personal digital assistants (PDAs), tablet computers, laptop computers (e.g., notebook, netbook, Ultrabook™, etc.), e-readers, etc. In yet other embodiments, computing device 100 may include server computers, desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, input/output (I/O) sources 108 (e.g., touchscreens, touch panels, touch pads, virtual or regular keyboards, virtual or regular mice, etc.), and a trusted execution environment 109.

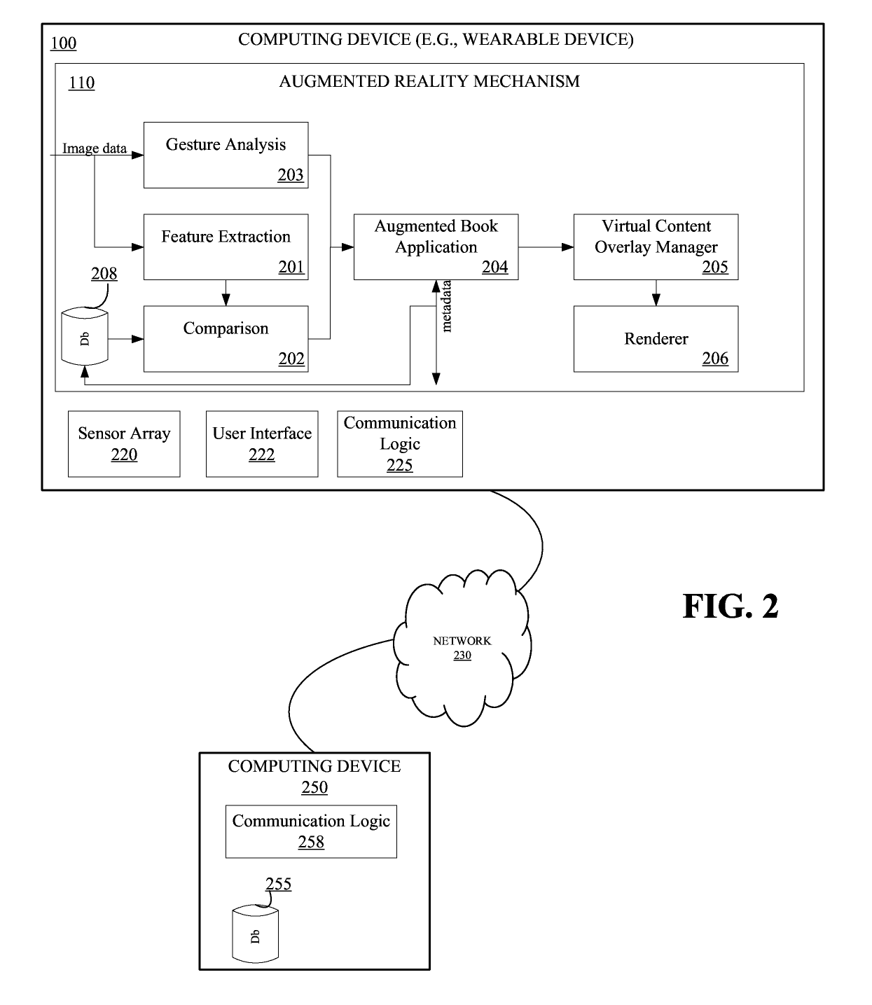

FIG. 2 illustrates an augmented reality mechanism 110 employed at computing device 100. In one embodiment, augmented reality mechanism 110 may include any number and type of modules and components, such as: feature extraction 201, comparison engine 202, gesture analysis 203, augmented book application 204, virtual content overlay manager 205 and renderer 206. In one embodiment, feature extraction 201 may receive audio and image data from sensor array 220, where the image data may be in the form of a sequence of images or frames (e.g., video frames). Sensor array 220 may include an image capturing device, such as a camera. Such a device may include various components, such as (but are not limited to) an optics assembly, an image sensor, an image/video encoder, etc., that may be implemented in any combination of hardware and/or software. The optics assembly may include one or more optical devices (e.g., lenses, mirrors, etc.) to project an image within a field of view onto multiple sensor elements within the image sensor. In addition, the optics assembly may include one or more mechanisms to control the arrangement of these optical device(s). For example, such mechanisms may control focusing operations, aperture settings, exposure settings, zooming operations, shutter speed, effective focal length, etc. Embodiments, however, are not limited to these examples.

Image sources may further include one or more image sensors including an array of sensor elements where these elements may be complementary metal oxide semiconductor (CMOS) sensors, charge coupled devices (CCDs), or other suitable sensor element types. These elements may generate analog intensity signals (e.g., voltages), which correspond to light incident upon the sensor. In addition, the image sensor may also include analog-to-digital converter(s) ADC(s) that convert the analog intensity signals into digitally encoded intensity values. Embodiments, however, are not limited to these examples. For example, an image sensor converts light received through optics assembly into pixel values, where each of these pixel values represents a particular light intensity at the corresponding sensor element. Although these pixel values have been described as digital, they may alternatively be analog. As described above, the image sensing device may include an image/video encoder to encode and/or compress pixel values. Various techniques, standards, and/or formats (e.g., Moving Picture Experts Group (MPEG), Joint Photographic Expert Group (JPEG), etc.) may be employed for this encoding and/or compression.

In a further embodiment, sensor array 220 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like.

In one embodiment, feature extraction 201 extracts features from image data received from each page as a user is reading a book. Comparison engine 202 compares the extracted features to data stored in a database 208. In one embodiment, database 208 may be an existing database of features created from a digital copy of the book by the publisher, or by crowdsourcing. Comparison engine 202 performs pattern matching operations to implement the feature comparisons. However in other embodiments, different mechanisms may be implemented (e.g., OCR, tracking, etc.).

Whenever the user reads the book, comparison engine 202 compares the extracted features to those in database 208. In one embodiment, augmented book application 204 receives the comparison results and determines whether a match is found. If a match is found, augmented book application 204 recognizes the book, as well as the page, the user is reading. As a result, augmented book application 204 retrieves metadata from database 208 associated with the extracted features. If a match is not found, however, augmented book application 204 stores the extracted features with associated book metadata in database 208.

According to one embodiment, user created information (e.g., notes, bookmarks, etc.), may be tagged on to existing information in database 208 and recalled by augmented book application 204 as required when a page/image match occurs. In a further embodiment, augmented book application 204 looks for a book title and a page number in header and footer sections of pages to quickly determine the book and page the user is reading.

Gesture analysis 203 performs one or more gesture classification algorithms and uses a rule engine to identify user gestures. According to one embodiment, augmented book application 204 performs an action corresponding to a detected gesture, captures the data corresponding to the performed gesture and tags the gesture data to the data to data for the page currently being viewed.

In such an embodiment, gestures may include highlighting, dictionary lookup, bookmarking, indexing and note taking, and cross-reference. A highlighting gesture may occur upon recognition of a user running a finger through a section of line or paragraph. If a highlighting gesture is recognized, augmented book application 204 highlights the section and captures and tags the information with the open page. When same page is subsequently accessed by the user, comparison engine 202 finds a match and augmented book application 204 recalls the highlight from book metadata stored either in database 208 or cloud storage.

The bookmarking gesture may occur upon recognition of a user pinching the top right corner of the open book. Upon detecting the bookmarking gesture, augmented book application 204 stores the page as a bookmark. Upon the user resuming reading of the book, augmented book application 204 recalls the bookmark and suggests user begin reading at the page number and top lines of the page.

An indexing and note taking gesture may occur upon a user creating a square bracket with index fingers and thumbs, or by drawing a virtual circle using a finger. A dictionary lookup gesture may occur upon detecting a virtual question mark over the word with a finger, while a cross-reference gesture may occur upon recognition of a user drawing a virtual arrow pointing towards or over a reference. In a further embodiment, audio prompts may be implemented. For instance, an audio prompt may be given by a user to bookmark a page (e.g., by speaking the words “book mark page 28”). In another embodiment, a virtual menu for a book may be created to invoke the stored information. In such an embodiment, the virtual menu is invoked by a user gesturing a menu item.

Virtual content overlay manager 205 overlays data (e.g., bookmark and highlighted data) on a book page, while renderer 206 renders the data for placement on a display device. In one embodiment, the data is seamlessly displayed over a page of the book the user is currently viewing. User interface 222 provides for user interaction with computing device 100. In one embodiment, user interface 222 enables a user to interact via gestures and/or audio commands in order to provide gesture data to gesture analysis 203.

Communication logic 225 may be used to facilitate dynamic communication and compatibility between various computing devices, such as computing device 100 and computing devices 250 (such as a mobile computing device, a desktop computer, a server computing device, etc.), storage devices, databases and/or data sources, networks, such as network 230 (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

It is contemplated that any number and type of components 201-225 of augmented reality mechanism 110 may not necessarily be at a single computing device and may be allocated among or distributed between any number and type of computing devices, including computing devices 100, 250 having (but are not limited to) server computing devices, cameras, PDAs, mobile phones (e.g., smartphones, tablet computers, etc.), personal computing devices (e.g., desktop devices, laptop computers, etc.), smart televisions, servers, wearable devices, media players, any smart computing devices, and so forth. Further examples include microprocessors, graphics processors or engines, microcontrollers, application specific integrated circuits (ASICs), and so forth. Embodiments, however, are not limited to these examples.

Communication logic 258 of computing device 250 may be similar to or the same as communication logic 225 of computing device 100 and may be used to facilitate augmented reality mechanism 110 at computing device 100 and one or more software applications at computing devices 250 over one or more networks, such as network 230. Further, logic 225 and 258 may be arranged or configured to use any one or more of communication technologies, such as wireless or wired communications and relevant protocols (e.g., Wi-Fi®, WiMAX, Ethernet, etc.), to facilitate communication over one or more networks, such as network 230 (e.g., Internet, intranet, cloud network, proximity network (e.g., Bluetooth, etc.).

In one embodiment, computing device 250 may be an augmented book server that includes a remote book metadata database 255. In other embodiments, computing device 250 may operate as a content server. According to one embodiment, computing device 100 may be in communication with computing device 250 over one or more networks, such as network 230 (e.g., cloud network, the Internet, intranet, cellular network, proximity or near proximity networks, etc.). Computing device 250 may further include communication logic 258, and one or more software applications.

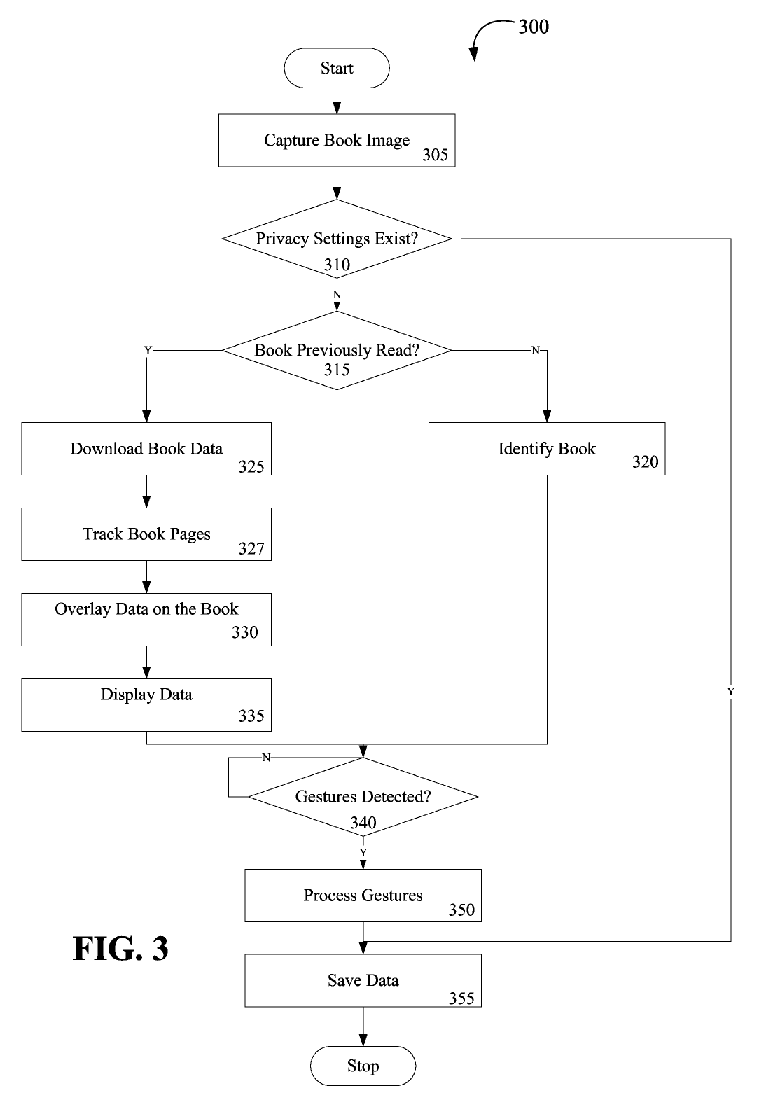

FIG. 3 is a flow diagram illustrating one embodiment of a process 300 performed by an augmented reality mechanism. Process 300 may be performed by processing logic that may comprise hardware (e.g., circuitry, dedicated logic, programmable logic, etc.), software (such as instructions run on a processing device), or a combination thereof. In one embodiment, process 300 may be performed by augmented reality mechanism 110. The processes of process 300 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1 and 2 are not discussed or repeated here.

At processing block 305, one or more images from the book are captured. At decision block 310, a determination is made as to whether privacy settings exist for the book. If privacy settings exist, process 300 is terminated. If, however, no privacy settings exist, a determination is made as to whether the book has been previously read by the user, decision block 315. If a determination is made that the book has not previously been read, the book is identified, processing block 320.

If a determination is made that the book has previously been read, the book data is downloaded from either cache 208 or database 255 at computing device 250, processing block 325. At processing block 327, the book pages are tracked. At processing block 330, bookmarks and highlighted data are overlaid on the book. At processing block 335, the data is rendered and displayed to the user at computing device 100. At decision block 340, a determination is made as to whether a user gesture is detected. If not, control remains at decision block 340 until a gesture is detected. Once detected, a gesture is processed at augmented book application 204, processing block 350. Subsequently, data corresponding to the processed gesture is saved at cache 208 or database 255 at computing device 250.

As discussed above, augmented reality mechanism 110 and process 300 permits a user implementing a wearable device to read a book to virtually highlight lines/sections of the book using a gesture, where gestures are identified and processed, and corresponding actions are taken. When the user reads that book again, augmented reality mechanism 110 remembers the highlighted lines and virtually highlights them again. Such a feature uses virtual overlays to enable real time tracking of books position and orientation with respect to the reader. Thus, the reader may virtually bookmark paper books borrowed from a library without physically damaging the books.

Another bookmarking embodiment features augmented reality mechanism 110 remembering where a user last closed the book. Thus, when the user reopens that book, augmented reality mechanism 110 reminds the user where to begin. The data may be stored locally at the wearable device, or on a server, and user can use any other copy of the same physical book to recall the bookmarks and all other artifacts. Accordingly, augmented reality mechanism 110 may provide cloud based support for crowd-sourced indexing, data analysis and contextual suggestions based on dynamic user defined data.

One implementation of augmented reality mechanism 110 may enable a user to create index/flash cards from some section of a books that the user may point to via a gesture (e.g., user may bracket Pythagoras theorem or any interesting area on the book by using index fingers and thumbs of his hands and augmented reality mechanism 110 creates an index card for it). The user may subsequently refer to these cards. In another embodiment, the user can look up the meaning of a word using a gesture (e.g., by drawing a “?” above the word). Additionally other multimedia information (e.g., audio, images and videos related to the word/term/subject matter can be automatically searched).

In another embodiment, the augmented reality mechanism may remember a word that the user looked up in the dictionary. In such an embodiment, the augmented reality mechanism may track the user's eye, and again display the word meaning upon the user encountering a subsequent occurrence of the word. In still a further embodiment, the same feature may be implemented for the Pythagoras theorem embodiment discussed above. In this embodiment, the augmented reality mechanism may display the formula if the user has highlighted, or created an index card, for the formula. In a further embodiment, a cloud based, crowd sourced service may keep a database of words to which that augmented reality mechanism 110 may refer, and display the formula right without user having to go back to the book, or perform an online search. In such an embodiment, cloud support may provide for synchronization of a user's e-book metadata with paper book based metadata to enhance user experience.

Augmented reality mechanism 110 may also perform virtual cross-referencing, in which a gesture is used (e.g., drawing an arrow over or towards a reference) to enable the user to automatically refer to e-sources outside of the book on a particular topic without having to look up a physical book or e-book, or a journal paper. The above-described user preference and data features may be implemented by a service provider to mine user databases and provide targeted advertisement based on a user's preference in the books.

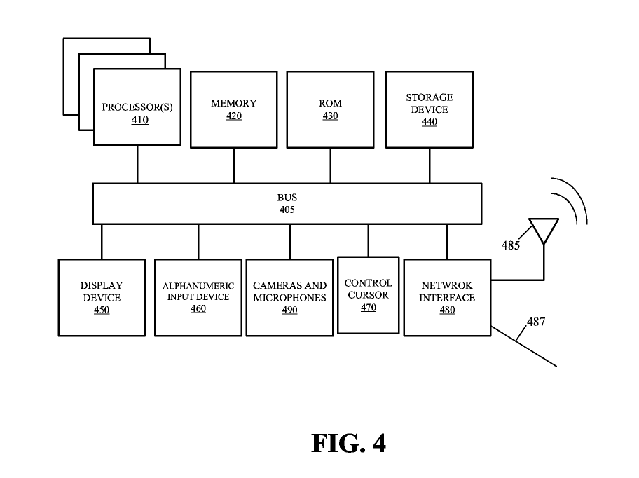

FIG. 4 illustrates one embodiment of a computer system 400, which may be implemented as computing device 100 and or computing device 250. Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an augmented reality apparatus comprising a sensor array to acquire image data from a book, a database, a feature extraction module to extract features from the image data as the book as being read, comparison engine to compare the extracted features to previously stored data in the database, an augmented book application to receive results of the comparison and retrieve page data associated with the extracted features upon detecting a comparison match, a virtual content overlay manager to overlay the page data on a book page currently being viewed and a display device to display the page data.

Example 2 includes the subject matter of Example 1, wherein the augmented book application stores the extracted features in the database upon determining no comparison match has been detected.

Example 3 includes the subject matter of Example 2, further comprising a gesture analysis module to receive the image data and identify a performed gesture, wherein the augmented book application performs an action corresponding to an identified gesture, tags associated page data with gesture data corresponding to the performed gesture and stores the gesture data and the page data in the database.

Example 4 includes the subject matter of Example 3, wherein the augmented book application retrieves the gesture data and the page data upon detecting a comparison match for a page on which the gesture has been performed and the virtual content overlay manager overlays the gesture data and the page data on the book page currently being viewed for display.

Example 5 includes the subject matter of Example 4, wherein the gesture analysis module receives audio data from the sensor array and performs a corresponding action indicated by the audio data.

Example 6 includes the subject matter of Example 5, wherein a gesture comprises one of highlighting, dictionary lookup, bookmarking, indexing and note taking, and cross-reference.

Example 7 includes the subject matter of Example 1, further comprising communication logic to communicate with the database via a network.

Example 8 includes the subject matter of Example 7, wherein the database comprises crowd-sourced data.

Example 9 includes the subject matter of Example 8, wherein page data from an electronic book is synchronized with the page data associated with the extracted features.

Some embodiments pertain to Example 10 that includes an augmented reality method comprising receiving image data from a book, extracting features from the image data as the book as being read, comparing the extracted features to previously stored data in the database, retrieving page data associated with the extracted features upon detecting a comparison match, overlaying the page data on a book page currently being viewed and displaying the page data on the book page currently being viewed.

Example 11 includes the subject matter of Example 10, further comprising determining whether privacy settings exist for the book prior to extracting features from the image data.

Example 12 includes the subject matter of Example 10, storing the extracted features in the database upon determining no comparison match has been detected.

Example 13 includes the subject matter of Example 12, further comprising identifying a performed gesture in the image data, performing an action corresponding to the identified gesture, tagging associated page data with gesture data corresponding to the performed gesture and storing the gesture data and the page data in the database.

Example 14 includes the subject matter of Example 13, further comprising retrieving the gesture data and the page data upon detecting a comparison match for a page on which the gesture has been performed, overlaying the gesture data and the page data on the book page currently being viewed and displaying the gesture data and the page data on the book page currently being viewed.

Example 15 includes the subject matter of Example 13, further comprising receiving audio data and identifying a gesture in the audio data.

Some embodiments pertain to Example 16 that includes a system to facilitate augmented reality comprising a server comprising a database, a network coupled to server, a wearable device, coupled to the network, comprising a sensor array to acquire image data from a book, a feature extraction module to extract features from the image data as the book as being read, comparison engine to compare the extracted features to previously stored data in the database, an augmented book application to receive results of the comparison and retrieve page data associated with the extracted features upon detecting a comparison match, a virtual content overlay manager to overlay the page data on a book page currently being viewed and a display device to display the page data.

Example 17 includes the subject matter of Example 16, wherein the augmented book application stores the extracted features in the database upon determining no comparison match has been detected.

Example 18 includes the subject matter of Example 17, wherein the wearable device further comprises a gesture analysis module to receive the image data and identify a performed gesture, wherein the augmented book application performs an action corresponding to the identified gesture, tags associated page data with gesture data corresponding to the performed gesture and stores the gesture data and the page data in the database.

Example 19 includes the subject matter of Example 18, wherein the augmented book application retrieves the gesture data and the page data upon detecting a comparison match for a page on which the gesture has been performed and the virtual content overlay manager overlays the gesture data and the page data on the book page currently being viewed for display.

Example 20 includes the subject matter of Example 19, wherein the gesture analysis module receives audio data from the sensor array and identifies a gesture in the audio data.

Example 21 includes the subject matter of Example 16, wherein the database comprises crowd-sourced data.

Some embodiments pertain to Example 22 that includes at least one machine-readable medium comprising a plurality of instructions that in response to being executed on a computing device, causes the computing device to carry out operations comprising receiving image data from a book, extracting features from the image data as the book as being read, comparing the extracted features to previously stored data in the database, retrieving page data associated with the extracted features upon detecting a comparison match, overlaying the page data on a book page currently being viewed and displaying the page data on the book page currently being viewed.

Example 23 includes the subject matter of Example 22, comprising a plurality of instructions that in response to being executed on a computing device, causes the computing device to further carry out operations comprising storing the extracted features in the database upon determining no comparison match has been detected.

Example 24 includes the subject matter of Example 23, comprising a plurality of instructions that in response to being executed on a computing device, causes the computing device to further carry out operations comprising identifying a performed gesture in the image data, performing an action corresponding to the identified gesture, tagging associated page data with gesture data corresponding to the performed gesture and storing the gesture data and the page data in the database.

Example 25 includes the subject matter of Example 24, comprising a plurality of instructions that in response to being executed on a computing device, causes the computing device to further carry out operations comprising retrieving the gesture data and the page data upon detecting a comparison match for a page on which the gesture has been performed, overlaying the gesture data and the page data on the book page currently being viewed and displaying the gesture data and the page data on the book page currently being viewed.

Some embodiments pertain to Example 26 that includes at least one machine-readable medium comprising a plurality of instructions that in response to being executed on a computing device, causes the computing device to carry out operations according to any of claims 10-15.

Some embodiments pertain to Example 27 that includes an apparatus to perform augmented reality comprising means for receiving image data from a book, means for extracting features from the image data as the book as being read, means for comparing the extracted features to previously stored data in the database, means for retrieving page data associated with the extracted features upon detecting a comparison match, means for overlaying the page data on a book page currently being viewed and means for displaying the page data on the book page currently being viewed.

Example 28 includes the subject matter of Example 27, further comprising means for storing the extracted features in the database upon determining no comparison match has been detected.

Example 29 includes the subject matter of Example 28, further comprising means for identifying a performed gesture in the image data, means for performing an action corresponding to the identified gesture, means for tagging associated page data with gesture data corresponding to the performed gesture and means for storing the gesture data and the page data in the database.

Example 30 includes the subject matter of Example 29 further comprising means for retrieving the gesture data and the page data upon detecting a comparison match for a page on which the gesture has been performed, means for overlaying the gesture data and the page data on the book page currently being viewed and means for displaying the gesture data and the page data on the book page currently being viewed.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An augmented reality apparatus comprising:
a sensor array to acquire image data from a book;
a database;
a feature extraction module to extract features from the image data as the book as being read;
comparison engine to compare the extracted features to previously stored data in the database;
an augmented book application to receive results of the comparison and retrieve page data associated with the extracted features upon detecting a comparison match;
a virtual content overlay manager to overlay the page data on a book page currently being viewed; and
a display device to display the page data.

2. The apparatus of claim 1 wherein the augmented book application stores the extracted features in the database upon determining no comparison match has been detected.

3. The apparatus of claim 2 further comprising a gesture analysis module to receive the image data and identify a performed gesture, wherein the augmented book application performs an action corresponding to the identified gesture, tags associated page data with gesture data corresponding to the performed gesture and stores the gesture data and the page data in the database.

4. The apparatus of claim 3 wherein the augmented book application retrieves the gesture data and the page data upon detecting a comparison match for a page on which the gesture has been performed and the virtual content overlay manager overlays the gesture data and the page data on the book page currently being viewed for display.

5. The apparatus of claim 3 wherein the gesture analysis module receives audio data from the sensor array and identifies a gesture in the audio data.

6. The apparatus of claim 5 wherein a gesture comprises one of highlighting, dictionary lookup, bookmarking, indexing and note taking, and cross-reference.

7. The apparatus of claim 1 further comprising communication logic to communicate with the database via a network.

8. The apparatus of claim 7 wherein the database comprises crowd-sourced data.

9. The apparatus of claim 8 wherein page data from an electronic book is synchronized with the page data associated with the extracted features.

10. An augmented reality method comprising:
receiving image data from a book;
extracting features from the image data as the book as being read;
comparing the extracted features to previously stored data in the database;
retrieving page data associated with the extracted features upon detecting a comparison match;
overlaying the page data on a book page currently being viewed; and
displaying the page data on the book page currently being viewed.

11. The method of claim 10 further comprising determining whether privacy settings exist for the book prior to extracting features from the image data.

12. The method of claim 10 further comprising storing the extracted features in the database upon determining no comparison match has been detected.

13. The method of claim 12 further comprising:
identifying a performed gesture in the image data;
performing an action corresponding to the identified gesture;
tagging associated page data with gesture data corresponding to the performed gesture; and
storing the gesture data and the page data in the database.

14. The method of claim 13 further comprising:
retrieving the gesture data and the page data upon detecting a comparison match for a page on which the gesture has been performed;
overlaying the gesture data and the page data on the book page currently being viewed; and
displaying the gesture data and the page data on the book page currently being viewed.

15. The method of claim 13 further comprising
receiving audio data; and
identifying a gesture in the audio data.

16. A system to facilitate augmented reality comprising:
a server comprising a database;
a network coupled to server;
a wearable device, coupled to the network, comprising:
a sensor array to acquire image data from a book;
a feature extraction module to extract features from the image data as the book as being read;
comparison engine to compare the extracted features to previously stored data in the database;
an augmented book application to receive results of the comparison and retrieve page data associated with the extracted features upon detecting a comparison match;
a virtual content overlay manager to overlay the page data on a book page currently being viewed; and
a display device to display the page data.

17. The system of claim 16 wherein the augmented book application stores the extracted features in the database upon determining no comparison match has been detected.

18. The system of claim 17 wherein the wearable device further comprises a gesture analysis module to receive the image data and identify a performed gesture, wherein the augmented book application performs an action corresponding to the identified gesture, tags associated page data with gesture data corresponding to the performed gesture and stores the gesture data and the page data in the database.

19. The system of claim 18 wherein the augmented book application retrieves the gesture data and the page data upon detecting a comparison match for a page on which the gesture has been performed and the virtual content overlay manager overlays the gesture data and the page data on the book page currently being viewed for display.

20. The system of claim 19 wherein the gesture analysis module receives audio data from the sensor array and identifies a gesture in the audio data.

21. The system of claim 16 wherein the database comprises crowd-sourced data.

22. At least one machine-readable medium comprising a plurality of instructions that in response to being executed on a computing device, causes the computing device to carry out operations comprising:
receiving image data from a book;
extracting features from the image data as the book as being read;
comparing the extracted features to previously stored data in the database;
retrieving page data associated with the extracted features upon detecting a comparison match;
overlaying the page data on a book page currently being viewed; and
displaying the page data on the book page currently being viewed.

23. The machine-readable medium of claim 22 comprising a plurality of instructions that in response to being executed on a computing device, causes the computing device to further carry out operations comprising storing the extracted features in the database upon determining no comparison match has been detected.

24. The machine-readable medium of claim 23 comprising a plurality of instructions that in response to being executed on a computing device, causes the computing device to further carry out operations comprising:
identifying a performed gesture in the image data;
performing an action corresponding to the identified gesture;
tagging associated page data with gesture data corresponding to the performed gesture; and
storing the gesture data and the page data in the database.

25. The machine-readable medium of claim 24 comprising a plurality of instructions that in response to being executed on a computing device, causes the computing device to further carry out operations comprising:
retrieving the gesture data and the page data upon detecting a comparison match for a page on which the gesture has been performed;
overlaying the gesture data and the page data on the book page currently being viewed; and
displaying the gesture data and the page data on the book page currently being viewed.
